(19) United States
(12) Patent Application Publication
(10) Pub. No.: US 2026/0361374 A1
(43) Pub. Date: Nov. 12, 2026

(54) UNIFIED TRANSMISSION CONFIGURATION INDICATOR (TCI) SWITCHING DELAYS

(71) Applicant: Apple Inc., Cupertino, CA (US)

(72) Inventors: Manasa Raghavan, Sunnyvale, CA (US); Jie Cui, San Jose, CA (US); Qiming Li, Beijing (CN); Yang Tang, San Jose, CA (US); Xiang Chen, Campbell, CA (US); Konstantinos Sarrigeorgidis, Los Gatos, CA (US); Yuexia Song, Beijing (CN); Rolando E. Bettancourt Ortega, Munich, Bavaria-Bayern (DE)

(21) Appl. No.: 19/125,687

(22) PCT Filed: Nov. 7, 2022
(86) PCT No.: PCT/CN2022/130273

§ 371 Date: Apr. 29, 2025

(51) Int. Cl. H04B 7/06; H04L 5/00

(52) U.S. Cl. CPC H04B 7/06952; H04L 5/001; H04L 5/0044; H04L 5/0053

(57) ABSTRACT

A user equipment (UE) receives a medium access control (MAC) control element (CE) (MAC CE) carrying an active downlink (or uplink) transmission configuration indicator (TCI) state list update. The active downlink (or uplink) TCI state list update includes a set of two or more new target TCI states associated with a set of two or more cells having different physical cell IDs (PCIs). The UE can receive or transmit in accord with at least one new target TCI state in the active downlink (or uplink) TCI state list update after a delay. The delay includes a measurement delay that is dependent on a frequency range in which a measurement is performed, and an overlap condition for the periodicities of two or more synchronization signal blocks (SSBs) or pathloss reference signals (PL-RSs). The overlap condition is selected from a set of two or more overlap conditions.

### TECHNICAL FIELD

This application relates generally to wireless communication systems, including methods and apparatus for specifying or managing unified TCI switching delays after receipt of an active downlink (DL) TCI state list update or an active uplink (UL) TCI state list update.

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example method of wireless communication by a UE, according to embodiments described herein.

FIGS. 3-5 show different example receipts of synchronization signal blocks (SSBs), by a UE, over time.

FIG. 6 shows another example method of wireless communication by a UE, according to embodiments described herein.

FIGS. 7-9 show different example receipts of pathloss reference signals (PL-RSs), by a UE, over time.

FIG. 10 illustrates an example architecture of a wireless communication system, according to embodiments described herein.

FIG. 11 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

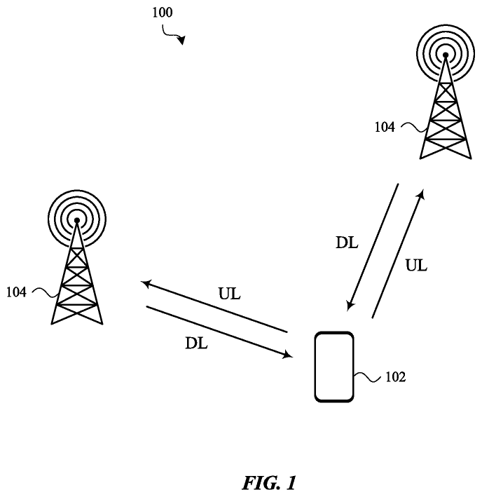

FIG. 1 shows an example wireless communications system 100. The wireless communications system includes a UE 102 that is connected, over the air, to a network (e.g., a 3GPP network). The UE 102 may communicate with the network on one or more ULs and one or more DLs, and more particularly may communicate with one or more network devices 104 (e.g., one or more base stations, remote radio heads, etc.) of a RAN on the one or more ULs and DLs. Depending on the capabilities of the UE 102 and the UE's configuration by the network, the UE 102 may communicate with the one or more network devices 104 simultaneously contemporaneously (e.g., in a multiple input multiple output (MIMO) mode) or sequentially (e.g., when handed over).

3GPP Technical Specification (TS) 38.133 defines radio resource management (RRM) requirements for a unified TCI framework. In particular, section 8.15 defines an active DL TCI state switching delay for unified TCI, and section 8.16 defines an active UL TCI state switching delay for unified TCI. For both the active DL TCI state switching delay and the active UL TCI state switching delay, there may be a medium access control (MAC) control element (CE) (MAC CE) based switching delay, a downlink control information (DCI) based switching delay, or an active TCI state list update delay. These delays may be applicable to a new target TCI state associated with a serving cell of a UE, and/or to a new target TCI state associated with a cell having a physical cell ID (PCI) that differs from the PCI of the serving cell.

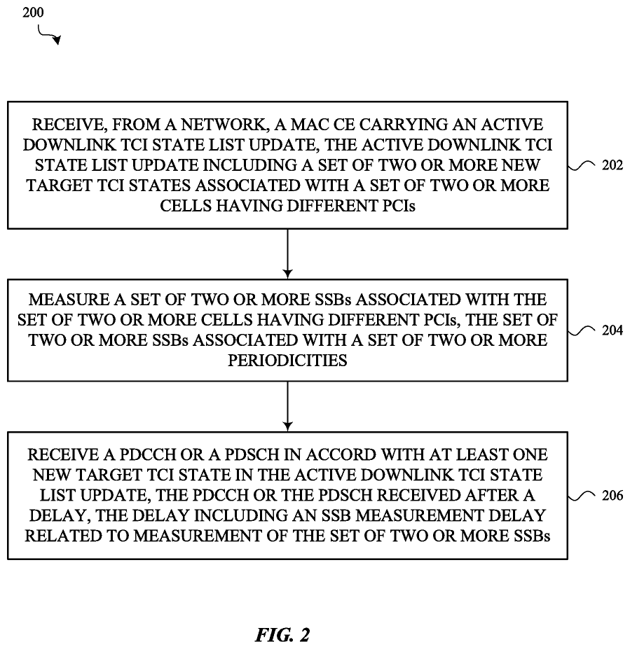

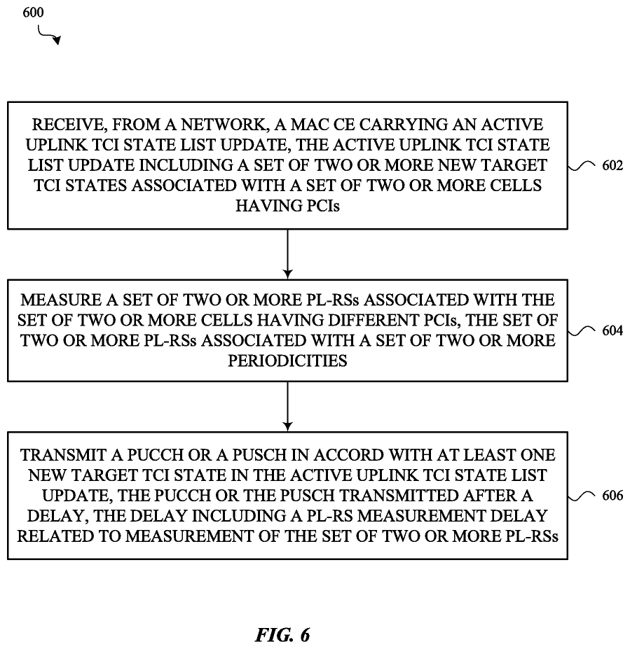

Described herein are improvements to the specification and management of the active downlink TCI state switching delay and active uplink TCI state switching delay defined in 3GPP TS 38.133. FIGS. 2-5 describe improvements to the active DL TCI state switching delay, and FIGS. 6-9 describe improvements to the active UL TCI state switching delay.

FIG. 2 shows an example method 200 of wireless communication by a UE. In some cases, the UE may be the UE described with reference to FIG. 1 or one of the other UEs described herein. The method 200 may be performed using a processor, a transceiver, or other components of the UE.

At 202, the method 200 may include receiving, from a network, a MAC CE carrying an active DL TCI state list update. The MAC CE may be received in a slot n. In some embodiments, the active DL TCI state list update may include a set of two or more new target TCI states associated with a set of two or more cells having different PCIs. For example, the active DL TCI state list update may include a first new target TCI state associated with a serving cell of the UE, and a second new target TCI state associated with a cell having a different PCI (i.e., a PCI that differs from the PCI of the serving cell). In some embodiments, the active DL TCI state list update may further include one or more additional new target TCI states, and each additional new target TCI state may be associated with an additional cell having a different new target TCI state. The active DL TCI state list update may also indicate or activate other TCI states (or fewer TCI states).

At 204, the method 200 may include measuring a set of two or more SSBs associated with the set of two or more cells having different PCIs. For example, when the set of two or more cells having different PCIs includes two cells—e.g., a serving cell of the UE and a cell having a PCI that differs from the PCI of the serving cell—the method 200 may include measuring an SSB associated with the serving cell and an SSB associated with the cell having a different PCI. The set of two or more SSBs may be associated with a set of two or more periodicities. For example, when the set of two or more cells having different PCIs includes two cells—e.g., a serving cell of the UE and a cell having a PCI that differs from the PCI of the serving cell—the SSB associated with the serving cell may have a first periodicity, and the SSB associated with the cell having a different PCI may have a second periodicity. The first and second periodicities may be the same or different, and may be aligned or non-aligned. When the first and second periodicities are the same and aligned, the occasions on which the UE may receive an SSB are the same for the serving cell and the cell having the different PCI (e.g., in a symbol in which an SSB can be received, the UE receives an SSB associated with the serving cell and an SSB associated with the cell having a different PCI). When the first and second periodicities differ and are aligned, then on an occasion in which the UE may receive an SSB, the UE may either 1) receive an SSB associated with the serving cell and an SSB associated with the cell having a different PCI, or 2) receive an SSB in accord with the higher periodicity (as between the first and second periodicities) but not receive an SSB in accord with the lower periodicity. When the first and second periodicities are the same or different, but not aligned, the occasions on which the UE may receive an SSB are different for the serving cell and the cell having the different PCI.

At 206, the method 200 may include may receiving and/or monitoring for a physical downlink control channel (PDCCH) or a physical downlink shared channel (PDSCH), in accord with at least one new target TCI state in the active DL TCI state list update. The PDCCH or the PDSCH may be received and/or monitored after a delay from receipt of the MAC CE, at 202. The delay may include an SSB measurement delay related to measurement of the set of two or more SSBs. The SSB measurement delay may depend on a frequency range in which the set of two or more SSBs is measured (or whether the UE is capable of simultaneously or contemporaneously receiving two or more SSBs omnidirectionally, on a single beam, or on multiple beams, in a particular frequency range), and/or an overlap condition for the set of two or more periodicities (e.g., the SSB measurement delay may be determined in different ways, depending on the frequency range and/or overlap condition). In some embodiments, the frequency range may be a frequency range in which SSBs of the set of two or more SSBs are measured simultaneously, such as in FR1, or a frequency range in which SSBs of the set of two or more SSBs are measured using a set of two or more beams formed at two or more different times, such as in FR2. The overlap condition may be selected from a set of two or more overlap conditions. In some embodiments, the overlap condition may be a full overlap condition, in which the set of two or more periodicities are the same and SSB occasions of different cells are aligned. In some embodiments, the overlap condition may be a partial overlap condition, in which the set of two or more periodicities differ, and the SSB occasions of a cell associated with a lower periodicity are aligned with some of the SSB occasions of a cell associated with a higher periodicity. In some embodiments, the overlap condition may be a non-overlap condition, in which 1) the two or more periodicities differ and no SSB occasions are aligned, or 2) the two or more periodicities are the same but no SSB occasions are aligned.

The method 200 may be variously embodied, extended, or adapted, as described in the following paragraphs and elsewhere in this description. Also, although embodiments described herein are sometimes described in terms of an active DL TCI state list update including a first new target TCI state associated with a serving cell of the UE and a second new target TCI state associated with a cell having a PCI that differs from the PCI of the serving cell, the described embodiments are examples only, and it is contemplated that the techniques described herein may be extended to active DL TCI state list updates including more than two new target TCI states and/or new target TCI states associated with more than two cells.

In some embodiments of the method 200, the SSB measurement delay may be determined using the equation:

TO*(T_{first-SSB_List}+T_{SSB-proc})/NR slot length

where TO is “1” if a target TCI state is not in the active TCI state list, and “0” otherwise; T_{first-SSB_List} is a time, following receipt of the MAC CE, that the UE needs to receive a measurable SSB from each of the two or more cells having different PCIs; T_{SSB-proc} is a time needed to finish and process SSB measurements after T_{first-SSB_List} (e.g., a time used to update time and frequency tracking loops); and NR slot length is a length of a slot in which the MAC CE is received.

In some embodiments of the method 200, the total delay that the UE may need to incur before receiving and/or monitoring for a PDCCH or a PDSCH using any desired TCI state of the new target TCI states, at 206, may be determined using the following equation:

$$n + {T}_{HARQ} + 3 {N}_{slot}^{subframe , μ} + TO * ( {T}_{first - SSB \_ List} + {T}_{SSB - proc} ) / NR slot length$$

where n is a slot number; T_{HARQ} is a hybrid automatic repeat request (HARQ) reporting delay (e.g., a timing between DL data transmission and acknowledgement as specified in 3GPP TS 38.213); and

$$3 {N}_{slot}^{subframe , μ}$$

is a slot-dependent delay.

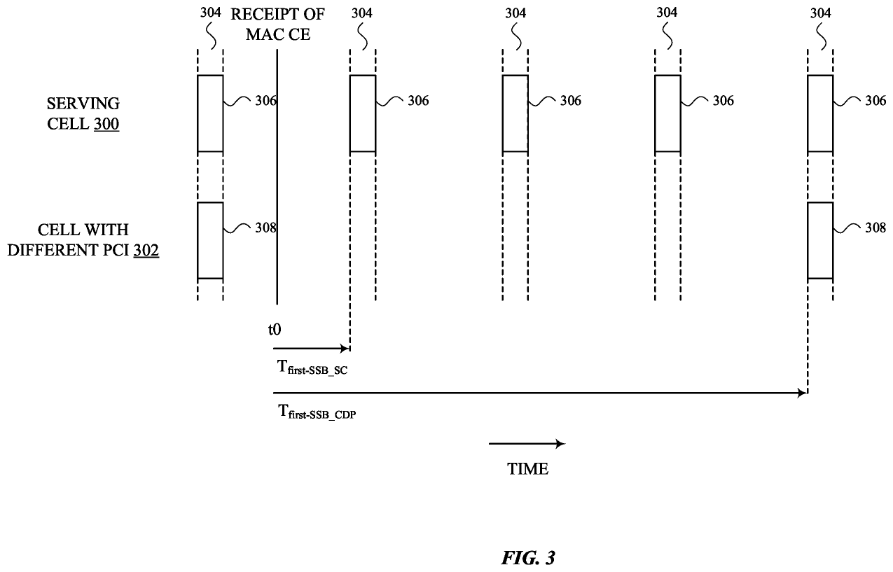

In some embodiments of the method 200, the frequency range may be a frequency range in which SSBs of the set of two or more SSBs can be measured simultaneously or contemporaneously (e.g., FR1 for a UE capable of omnidirectional reception, or FR2 for a UE capable of receiving on two or more beams), and the overlap condition may be a partial overlap condition in which each cell of the two or more cells having different PCIs has a different time to first SSB following receipt of the MAC CE. Alternatively, the frequency range may be a frequency range in which SSBs of the set of two or more SSBs are measured using a set of two or more beams formed at two or more different times (e.g., FR2 for a UE capable of receiving on only one beam), and the overlap condition may be a partial overlap condition in which each cell of the two or more cells having different PCIs has a different time to first SSB following receipt of the MAC CE. In these embodiments, the SSB measurement delay may be based on a maximum time to first SSB, selected from the different times to first SSB following receipt of the MAC CE. Such an SSB measurement delay allows the UE to measure SSBs associated with each of the two or more cells having different PCIs. An example of these embodiments is illustrated with reference to FIG. 3.

FIG. 3 shows an example receipt of SSBs, by a UE, over time. The SSBs are associated with first and second cells 300, 302, and are received during a number of occasions 304 for receiving SSBs. By way of example, the first cell 300 is a serving cell of the UE, and the second cell 302 is a cell having a PCI that differs from the PCI of the serving cell 300. The SSBs 306 associated with the first cell 300 have a first periodicity, and the first periodicity is higher than a second periodicity of the SSBs 308 associated with the second cell 302. Alternatively, the first and second periodicities may be swapped, or the SSBs 306, 308 associated with the first and second cells 300, 302 may be associated with other periodicities.

A MAC CE carrying an active DL TCI state list update may be received, by the UE, at a time t0. A time to first SSB following receipt of the MAC CE, for the first cell 300, is identified as T_{first-SSB_SC}, and a time to first SSB following receipt of the MAC CE, for the second cell 302, is identified as T_{first-SSB_CDP}. The maximum time to first SSB, in this example, is T_{first-SSB_CDP}. In this example, T_{first-SSB_List} in the above-described SSB measurement delay may be determined as:

T_{first-SSB_List}=max(T_{first-SSB_SC}, T_{first-SSB_CDP})

More generally, and for an arbitrary number of cells having different PCIs, T_{first-SSB_List} may be determined as:

T_{first-SSB_List}=max(T_{first-SSB_SC}, T_{first-SSB_CDP,1}, T_{first-SSB_CDP,2}, . . . T_{first-SSB_CDP,Nmax})

for Nmax cells having different PCIs.

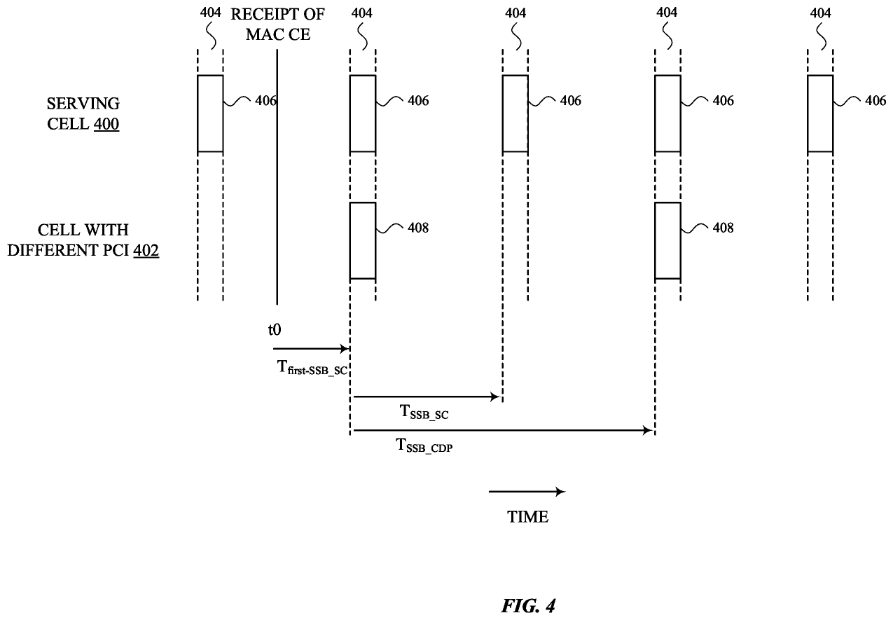

In some embodiments of the method 200, the frequency range may be a frequency range in which SSBs of the set of two or more SSBs can be measured simultaneously or contemporaneously (e.g., FR1 for a UE capable of omnidirectional reception, or FR2 for a UE capable of receiving on two or more beams), and the overlap condition may be a partial overlap condition, in which each cell of the two or more cells having different PCIs has a same time to first SSB following receipt of the MAC CE. In these embodiments, the SSB measurement delay may be based on the same time to SSB, since the UE may measure SSBs associated with the two or more cells simultaneously or contemporaneously. Such an SSB measurement delay allows the UE to measure SSBs associated with each of the two or more cells having different PCIs. An example of these embodiments is illustrated with reference to FIG. 4.

FIG. 4 shows an example receipt of SSBs, by a UE, over time. The SSBs are associated with first and second cells 400, 402, and are received during a number of occasions 404 for receiving SSBs. By way of example, the first cell 400 is a serving cell of the UE, and the second cell 402 is a cell having a PCI that differs from the PCI of the serving cell 400. The SSBs 406 associated with the first cell 400 have a first periodicity, and the first periodicity is higher than a second periodicity of the SSBs 408 associated with the second cell 402. Alternatively, the first and second periodicities may be swapped, or the SSBs 406, 408 associated with the first and second cells 400, 402 may be associated with other periodicities.

A MAC CE carrying an active DL TCI state list update may be received, by the UE, at a time t0. A time to first SSB following receipt of the MAC CE, for the first cell 400, is identified as T_{first-SSB_SC}, and the time to first SSB following receipt of the MAC CE, for the second cell 402, is also equal to T_{first-SSB_SC}. If SSBs of the set of two or more SSBs can be measured simultaneously or contemporaneously (e.g., in FR1), then:

T_{first-SSB_List}=T_{first-SSB_SC}

regardless of whether SSBs are measured for two cells having different PCIs or more than two cells having different PCIs.

In some embodiments of the method 200, the frequency range may be a frequency range in which SSBs of the set of two or more SSBs are measured using a set of two or more beams formed at two or more different times (e.g., FR2 for a UE capable of receiving on only one beam), and the overlap condition may be a partial overlap condition, in which each cell of the two or more cells having different PCIs has a same time to first SSB following receipt of the MAC CE. In these embodiments, the SSB measurement delay may be based on the same time to SSB plus a shortest period of the set of two or more periodicities, since the UE cannot measure SSBs associated with the two or more cells simultaneously or contemporaneously. Such an SSB measurement delay allows the UE to measure SSBs associated with each of the two or more cells having different PCIs. An example of these embodiments is also illustrated with reference to FIG. 4.

In FIG. 4, a time to first SSB following receipt of the MAC CE, for the first cell 400 and the second cell 402, is identified as T_{first-SSB_SC}. If the UE measures the SSB for the cell associated with the lowest periodicity (i.e., longest period) after T_{first-SSB_SC} (i.e., at the first occasion 404 for receiving SSBs), then the UE can measure the SSB for the cell associated with the highest periodicity (i.e., shortest period) at the next occasion 404 for receiving SSBs. If the SSBs 406 associated with the first cell 400 have a first periodicity of T_{SSB_SC}, and the SSBs 408 associated with the second cell 402 have a second periodicity of T_{SSB_CDP}, then T_{first-SSB_List} may be determined as:

T_{first-SSB_List}=T_{first-SSB_SC}+min(T_{SSB_SC}, T_{SSB_CDP})

For an arbitrary number of cells having different PCIs, a particular combination of overlapping and non-overlapping SSBs, at different occasions for receiving SSBs, need to be considered to determine a minimum required value for T_{first-SSB_List}.

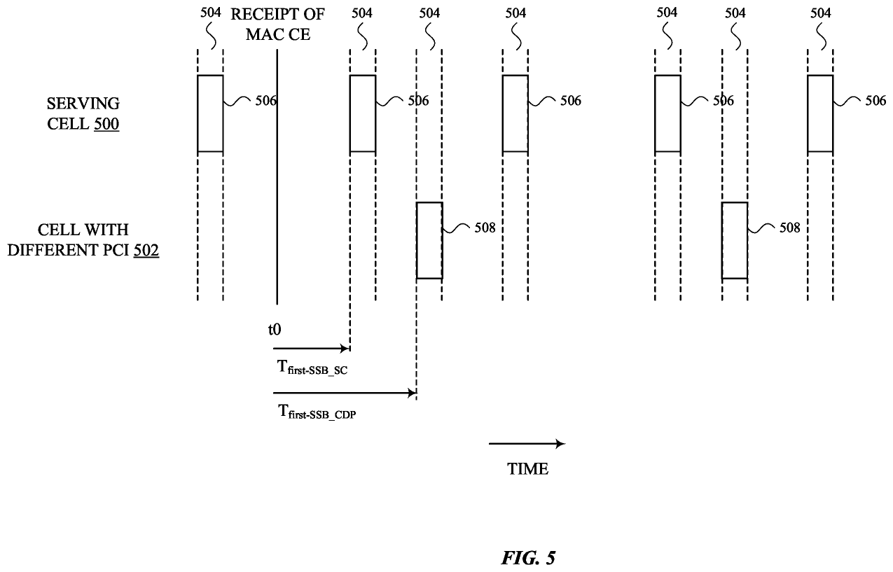

In some embodiments of the method 200, the frequency range may be a frequency range in which SSBs of the set of two or more SSBs can be measured simultaneously or contemporaneously (e.g., FR1 for a UE capable of omnidirectional reception, or FR2 for a UE capable of receiving on two or more beams), and the overlap condition may be a non-overlap condition in which each cell of the two or more cells having different PCIs has a different time to first SSB following receipt of the MAC CE. Alternatively, the frequency range may be a frequency range in which SSBs of the set of two or more SSBs are measured using a set of two or more beams formed at two or more different times (e.g., FR2 for a UE capable of receiving on only one beam), and the overlap condition may be a non-overlap condition in which each cell of the two or more cells having different PCIs has a different time to first SSB following receipt of the MAC CE. In these embodiments, the SSB measurement delay may be based on a maximum time to first SSB, selected from the different times to first SSB following receipt of the MAC CE. Such an SSB measurement delay allows the UE to measure SSBs associated with each of the two or more cells having different PCIs. An example of these embodiments is illustrated with reference to FIG. 5.

FIG. 5 shows an example receipt of SSBs, by a UE, over time. The SSBs are associated with first and second cells 500, 502, and are received during a number of occasions 504 for receiving SSBs. By way of example, the first cell 500 is a serving cell of the UE, and the second cell 502 is a cell having a PCI that differs from the PCI of the serving cell 500. The SSBs 506 associated with the first cell 500 have a first periodicity, and the first periodicity is higher than a second periodicity of the SSBs 508 associated with the second cell 502. Alternatively, the first and second periodicities may be swapped, or the SSBs 506, 508 associated with the first and second cells 500, 502 may be associated with other periodicities.

A MAC CE carrying an active DL TCI state list update may be received, by the UE, at a time t0. A time to first SSB following receipt of the MAC CE, for the first cell 500, is identified as T_{first-SSB_SC}, and a time to first SSB following receipt of the MAC CE, for the second cell 502, is identified as T_{first-SSB_CDP}. The maximum time to first SSB, in this example, is T_{first-SSB_CDP}. In this example, T_{first-SSB_List} in the above SSB measurement delay may be determined as:

T_{first-SSB_List}=max(T_{first-SSB_SC}, T_{first-SSB_CDP})

More generally, and for an arbitrary number of cells having different PCIs, T_{first-SSB_List} may be determined as:

T_{first-SSB_List}=max(T_{first-SSB_SC}, T_{first-SSB_CDP,1}, T_{first-SSB_CDP,2}, . . . T_{first-SSB_CDP,Nmax})

for Nmax cells having different PCIs.

FIG. 6 shows an example method 600 of wireless communication by a UE. In some cases, the UE may be the UE described with reference to FIG. 1 or one of the other UEs described herein. The method 600 may be performed using a processor, a transceiver, or other components of the UE.

At 602, the method 600 may include receiving, from a network, a MAC CE carrying an active UL TCI state list update. The MAC CE may be received in a slot n. In some embodiments, the active UL TCI state list update may include a set of two or more new target TCI states associated with a set of two or more cells having different PCIs. For example, the active UL TCI state list update may include a first new target TCI state associated with a serving cell of the UE, and a second new target TCI state associated with a cell having a different PCI (i.e., a PCI that differs from the PCI of the serving cell). In some embodiments, the active UL TCI state list update may further include one or more additional new target TCI states, and each additional new target TCI state may be associated with an additional cell having a different new target TCI state. The active UL TCI state list update may also indicate or activate other TCI states (or fewer TCI states).

At 604, the method 600 may include measuring a set of two or more PL-RSs associated with the set of two or more cells having different PCIs. For example, when the set of two or more cells having different PCIs includes two cells—e.g., a serving cell of the UE and a cell having a PCI that differs from the PCI of the serving cell—the method 600 may include measuring a PL-RS associated with the serving cell and a PL-RS associated with the cell having a different PCI. The set of two or more PL-RSs may be associated with a set of two or more periodicities. For example, when the set of two or more cells having different PCIs includes two cells—e.g., a serving cell of the UE and a cell having a PCI that differs from the PCI of the serving cell—the PL-RS associated with the serving cell may have a first periodicity, and the PL-RS associated with the cell having a different PCI may have a second periodicity. The first and second periodicities may be the same or different, and may be aligned or non-aligned. When the first and second periodicities are the same and aligned, the occasions on which the UE may receive a PL-RS are the same for the serving cell and the cell having the different PCI (e.g., in a symbol in which a PL-RS can be received, the UE receives a PL-RS associated with the serving cell and a PL-RS associated with the cell having a different PCI). When the first and second periodicities differ and are aligned, then on an occasion in which the UE may receive a PL-RS, the UE may either 1) receive a PL-RS associated with the serving cell and a PL-RS associated with the cell having a different PCI, or 2) receive a PL-RS in accord with the higher periodicity (as between the first and second periodicities) but not receive a PL-RS in accord with the lower periodicity. When the first and second periodicities are the same or different, but not aligned, the occasions on which the UE may receive a PL-RS are different for the serving cell and the cell having the different PCI.

At 606, the method 600 may include transmitting a physical uplink control channel (PUCCH) or a physical uplink shared channel (PUSCH), in accord with at least one new target TCI state in the active UL TCI state list update. The PUCCH or the PUSCH may be transmitted after a delay from receipt of the MAC CE, at 602. The delay may include a PL-RS measurement delay related to measurement of the set of two or more PL-RSs. The PL-RS measurement delay may depend on a frequency range in which the set of two or more PL-RSs is measured (or whether the UE is capable of simultaneously or contemporaneously receiving two or more PL-RSs omnidirectionally, on a single beam, or on multiple beams, in a particular frequency range), and/or an overlap condition for the set of two or more periodicities (e.g., the PL-RS measurement delay may be determined in different ways, depending on the frequency range and/or overlap condition). In some embodiments, the frequency range may be a frequency range in which PL-RSs of the set of two or more PL-RSs are measured simultaneously or contemporaneously, such as in FR1, or a frequency range in which PL-RSs of the set of two or more PL-RSs are measured using a set of two or more beams formed at two or more different times, such as in FR2. The overlap condition may be selected from a set of two or more overlap conditions. In some embodiments, the overlap condition may be a full overlap condition, in which the set of two or more periodicities are the same and PL-RS occasions of different cells are aligned. In some embodiments, the overlap condition may be a partial overlap condition, in which the set of two or more periodicities differ, and the PL-RS occasions of a cell associated with a lower periodicity are aligned with some of the PL-RS occasions of a cell associated with a higher periodicity. In some embodiments, the overlap condition may be a non-overlap condition, in which 1) the two or more periodicities differ and no PL-RS occasions are aligned, or 2) the two or more periodicities are the same but no PL-RS occasions are aligned.

The method 600 may be variously embodied, extended, or adapted, as described in the following paragraphs and elsewhere in this description. Also, although embodiments described herein are sometimes described in terms of an active UL TCI state list update including a first new target TCI state associated with a serving cell of the UE and a second new target TCI state associated with a cell having a PCI that differs from the PCI of the serving cell, the described embodiments are examples only, and it is contemplated that the techniques described herein may be extended to active UL TCI state list updates including more than two new target TCI states and/or new target TCI states associated with more than two cells.

In some embodiments of the method 600, the PL-RS measurement delay may be determined using the equation:

NM*(T_{first_target-PL-RS_List}+4*T_{target-PL-RS_List}+2ms)/NR slot length

where NM has a value of “1” when a PL-RS is not maintained by the UE, and “0” when all PL-RSs required by the active UL TCI state list update are maintained by the UE (where “not maintained” means a target PL-RS that is required by the active UL TCI state list update (i.e., a PL-RS that needs to be measured) is not in the active UL TCI state list, or if the number of PL-RS in the active UL TCI state list exceeds four (4)); T_{first_target-PL-RS_List} is a time, following receipt of the MAC CE, that the UE needs to receive a first measurable PL-RS from each of the two or more cells having different PCIs; T_{target_PL-RS_List} is a time needed to receive a next measurable PL-RS from each of the two or more cells having different PCIs; and NR slot length is a length of a slot in which the MAC CE is received.

In some embodiments of the method 600, the total delay that the UE may need to incur before transmitting a PUCCH or a PUSCH using any desired TCI state of the new target TCI states, at 606, may be determined using the following equation:

$$n + {T}_{HARQ} + 3 {N}_{slot}^{subframe , μ} + NM * ( {T}_{{first}_{target} - PL - {RS}_{List}} + 4 * {T}_{target - PL - {RS}_{List}} + 2 ms ) / NR slot length$$

where n is a slot number; T_{HARQ} is a hybrid automatic repeat request (HARQ) reporting delay (e.g., a timing between DL data transmission and acknowledgement as specified in 3GPP TS 38.213); and

$$3 {N}_{slot}^{subframe , μ}$$

is a slot-dependent delay.

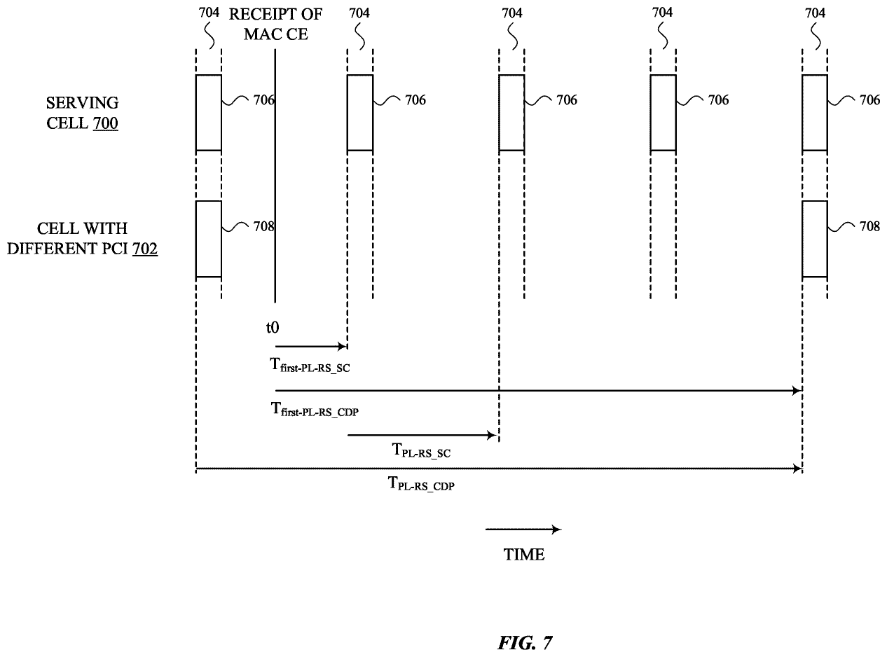

In some embodiments of the method 600, the frequency range may be a frequency range in which PL-RSs of the set of two or more PL-RSs can be measured simultaneously or contemporaneously (e.g., FR1 for a UE capable of omnidirectional reception, or FR2 for a UE capable of receiving on two or more beams), and the overlap condition may be a partial overlap condition in which each cell of the two or more cells having different PCIs has a different time to first PL-RS following receipt of the MAC CE. Alternatively, the frequency range may be a frequency range in which PL-RSs of the set of two or more PL-RSs are measured using a set of two or more beams formed at two or more different times (e.g., FR2 for a UE capable of receiving on only one beam), and the overlap condition may be a partial overlap condition in which each cell of the two or more cells having different PCIs has a different time to first PL-RS following receipt of the MAC CE. In these embodiments, the PL-RS measurement delay may be based on 1) a maximum time to first PL-RS, selected from the different times to first PL-RS following receipt of the MAC CE, and 2) a greatest period of the two or more periodicities. Such a PL-RS measurement delay allows the UE to measure PL-RSs associated with each of the two or more cells having different PCIs. An example of these embodiments is illustrated with reference to FIG. 7.

FIG. 7 shows an example receipt of PL-RSs, by a UE, over time. The PL-RSs are associated with first and second cells 700, 702, and are received during a number of occasions 704 for receiving PL-RSs. By way of example, the first cell 700 is a serving cell of the UE, and the second cell 702 is a cell having a PCI that differs from the PCI of the serving cell 700. The PL-RSs 706 associated with the first cell 700 have a first periodicity, and the first periodicity is higher than a second periodicity of the PL-RSs 708 associated with the second cell 702. Alternatively, the first and second periodicities may be swapped, or the PL-RSs 706, 708 associated with the first and second cells 700, 702 may be associated with other periodicities.

A MAC CE carrying an active UL TCI state list update may be received, by the UE, at a time t0. A time to first PL-RS following receipt of the MAC CE, for the first cell 700, is identified as T_{first-PL-RS_SC}, and a time to first PL-RS following receipt of the MAC CE, for the second cell 702, is identified as T_{first-PL-RS_CDP}. The maximum time to first PL-RS, in this example, is T_{first-PL-RS_CDP}. In this example, T_{first_target-PL-RS_List} in the above-described PL-RS measurement delay may be determined as:

T_{first_target-PL-RS_List}=max(T_{first-PL-RS_SC}, T_{first-PL-RS_CDP})

More generally, and for an arbitrary number of cells having different PCIs, T_{first_target-PL-RS_List} may be determined as:

T_{first_target-PL-RS_List}=max(T_{first-PL-RS_SC}, T_{first-PL-RS_CDP,1}, T_{first-PL-RS_CDP,2}, . . . T_{first-PL-RS_CDP,Nmax})

for Nmax cells having different PCIs.

The greatest period of the set of two or more periodicities, in FIG. 7, is T_{PL-RS,SC}, and may be determined as:

T_{target-PL-RS_List}=max(T_{PL-RS_SC}, T_{PL-RS_CDP})

More generally, and for an arbitrary number of cells having different PCIs, T_{target-PL-RS_List} may be determined as:

T_{target-PL-RS_List}=max(T_{PL-RS_SC}, T_{PL-RS_CDP,1}, T_{PL-RS_CDP,2}, . . . T_{PL-RS_CDP,Nmax})

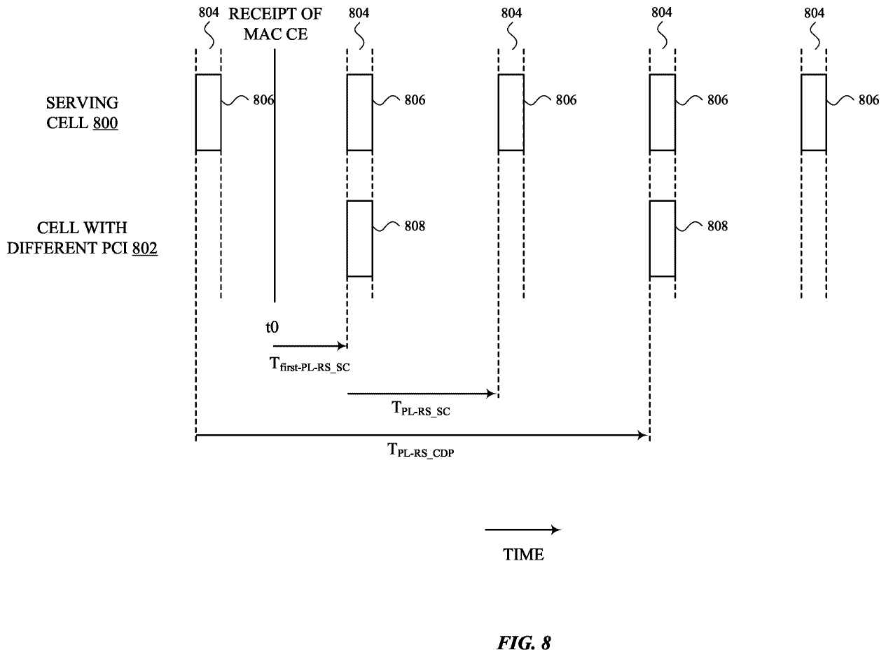

In some embodiments of the method 600, the frequency range may be a frequency range in which SSBs of the set of two or more PL-RSs can be measured simultaneously or contemporaneously (e.g., FR1 for a UE capable of omnidirectional reception, or FR2 for a UE capable of receiving on two or more beams), and the overlap condition may be a partial overlap condition, in which each cell of the two or more cells having different PCIs has a same time to first PL-RS following receipt of the MAC CE. In these embodiments, the PL-RS measurement delay may be based on 1) the same time to PL-RS, since the UE may measure SSBs associated with the two or more cells simultaneously or contemporaneously, and 2) a greatest period of the two or more periodicities. Such a PL-RS measurement delay allows the UE to measure PL-RSs associated with each of the two or more cells having different PCIs. An example of these embodiments is illustrated with reference to FIG. 8.

FIG. 8 shows an example receipt of PL-RSs, by a UE, over time. The PL-RSs are associated with first and second cells 800, 802, and are received during a number of occasions 804 for receiving PL-RSs. By way of example, the first cell 800 is a serving cell of the UE, and the second cell 802 is a cell having a PCI that differs from the PCI of the serving cell 800. The PL-RSs 806 associated with the first cell 800 have a first periodicity, and the first periodicity is higher than a second periodicity of the PL-RSs 808 associated with the second cell 802. Alternatively, the first and second periodicities may be swapped, or the PL-RSs 806, 808 associated with the first and second cells 800, 802 may be associated with other periodicities.

A MAC CE carrying an active UL TCI state list update may be received, by the UE, at a time t0. A time to first PL-RS following receipt of the MAC CE, for the first cell 800, is identified as T_{first-PL-RS_SC}, and the time to first PL-RS following receipt of the MAC CE, for the second cell 802, is also equal to T_{first-PL-RS_SC}. If PL-RSs of the set of two or more PL-RSs can be measured simultaneously or contemporaneously (e.g., in FR1), then:

T_{first_target-PL-RS_List}=T_{first-PL-RS_SC}

regardless of whether PL-RSs are measured for two cells having different PCIs or more than two cells having different PCIs.

The greatest period of the set of two or more periodicities, in FIG. 8, may be determined as described with reference to FIG. 7.

In some embodiments of the method 600, the frequency range may be a frequency range in which PL-RSs of the set of two or more PL-RSs are measured using a set of two or more beams formed at two or more different times (e.g., FR2 for a UE capable of receiving on only one beam), and the overlap condition may be a partial overlap condition, in which each cell of the two or more cells having different PCIs has a same time to first PL-RS following receipt of the MAC CE. In these embodiments, the PL-RS measurement delay may be based on 1) the same time to PL-RS plus a shortest period of the set of two or more periodicities, since the UE cannot measure PL-RSs associated with the two or more cells simultaneously or contemporaneously, and 2) a greatest period of the two or more periodicities. Such a PL-RS measurement delay allows the UE to measure PL-RSs associated with each of the two or more cells having different PCIs. An example of these embodiments is also illustrated with reference to FIG. 8.

In FIG. 8, a time to first PL-RS following receipt of the MAC CE, for the first cell 800 and the second cell 802, is identified as T_{first-PL-RS_SC}. If the UE measures the PL-RS for the cell associated with the lowest periodicity (i.e., longest period) after T_{first-PL-RS_SC} (i.e., at the first occasion 804 for receiving PL-RSs), then the UE can measure the PL-RS for the cell associated with the highest periodicity (i.e., shortest period) at the next occasion 804 for receiving PL-RSs. If the PL-RSs 806 associated with the first cell 800 have a first periodicity of T_{PL-RS_SC}, and the SSBs 808 associated with the second cell 802 have a second periodicity of T_{PL-RS_CDP}, then T_{first_target-PL-RS_List} may be determined as:

T_{first_target-PL-RS_List}=T_{first-PL-RS_SC}+min(T_{PL-RS_SC}, T_{PL-RS_CDP})

For an arbitrary number of cells having different PCIs, a particular combination of overlapping and non-overlapping PL-RSs, at different occasions for receiving PL-RSs, need to be considered to determine a minimum required value for T_{first_target-PL-RS_List}.

The greatest period of the set of two or more periodicities, in FIG. 8, may be determined as described with reference to FIG. 7.

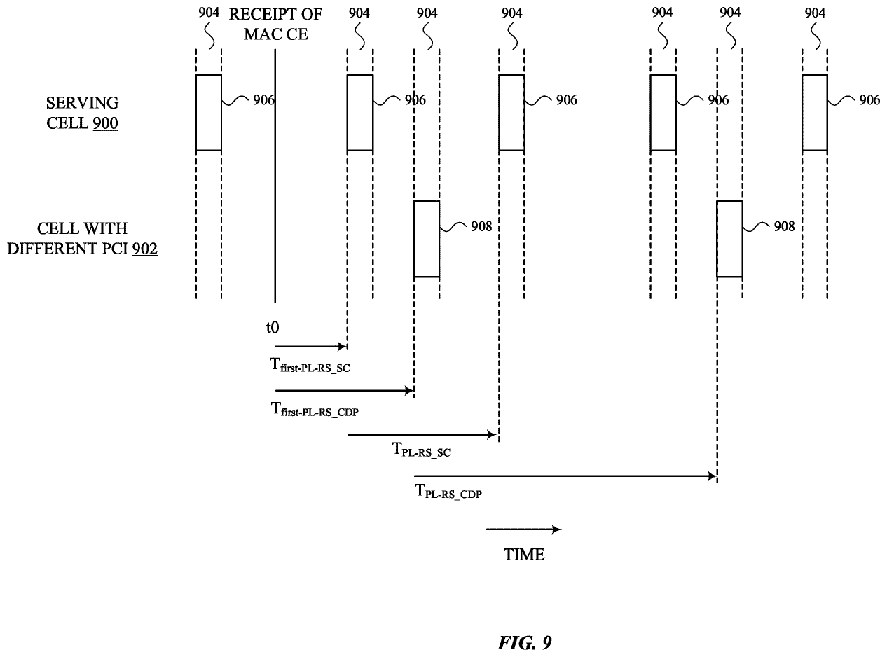

In some embodiments of the method 600, the frequency range may be a frequency range in which PL-RSs of the set of two or more PL-RSs can be measured simultaneously or contemporaneously (e.g., FR1 for a UE capable of omnidirectional reception, or FR2 for a UE capable of receiving on two or more beams), and the overlap condition may be a non-overlap condition in which each cell of the two or more cells having different PCIs has a different time to first PL-RS following receipt of the MAC CE. Alternatively, the frequency range may be a frequency range in which PL-RSs of the set of two or more PL-RSs are measured using a set of two or more beams formed at two or more different times, and the overlap condition may be a non-overlap condition in which each cell of the two or more cells having different PCIs has a different time to first PL-RS following receipt of the MAC CE. In these embodiments, the PL-RS measurement delay may be based on 1) a maximum time to first PL-RS, selected from the different times to first PL-RS following receipt of the MAC CE, and 2) a greatest period of the set of two or more periodicities. Such a PL-RS measurement delay allows the UE to measure PL-RSs associated with each of the two or more cells having different PCIs. An example of these embodiments is illustrated with reference to FIG. 9.

FIG. 9 shows an example receipt of PL-RSs, by a UE, over time. The PL-RSs are associated with first and second cells 900, 902, and are received during a number of occasions 904 for receiving PL-RSs. By way of example, the first cell 900 is a serving cell of the UE, and the second cell 902 is a cell having a PCI that differs from the PCI of the serving cell 900. The PL-RSs 906 associated with the first cell 900 have a first periodicity, and the first periodicity is higher than a second periodicity of the PL-RSs 908 associated with the second cell 902. Alternatively, the first and second periodicities may be swapped, or the PL-RSs 906, 908 associated with the first and second cells 900, 902 may be associated with other periodicities.

A MAC CE carrying an active UL TCI state list update may be received, by the UE, at a time t0. A time to first PL-RS following receipt of the MAC CE, for the first cell 900, is identified as T_{first-PL-RS_SC}, and a time to first PL-RS following receipt of the MAC CE, for the second cell 902, is identified as T_{first-PL-RS_CDP}. The maximum time to first PL-RS, in this example, is T_{first-PL-RS_CDP}. In this example, T_{first_target-PL-RS_List} in the above PL-RS measurement delay may be determined as:

T_{first_target-PL-RS_List}=max(T_{first-PL-RS_SC}, T_{first-PL-RS_CDP})

More generally, and for an arbitrary number of cells having different PCIs, T_{first_target-PL-RS_List} may be determined as:

T_{first_target-PL-RS_List}=max(T_{first-PL-RS_SC}, T_{first-PL-RS_CDP,1}, T_{first-PL-RS_CDP,2}, . . . T_{first-PL-RS_CDP,Nmax})

for Nmax cells having different PCIs.

The greatest period of the set of two or more periodicities, in FIG. 8, may be determined as described with reference to FIG. 7.

Embodiments contemplated herein include one or more non-transitory computer-readable media storing instructions to cause an electronic device, upon execution of the instructions by one or more processors of the electronic device, to perform one or more elements of the method 200 or 600. In the context of method 200, this non-transitory computer-readable media may be, for example, a memory of a UE (such as a memory 1106 of a wireless device 1102 that is a UE, as described herein). In the context of method 600, this non-transitory computer-readable media may be, for example, a memory of a network device (such as a memory 1124 of a network device 1120, as described herein).

Embodiments contemplated herein include an apparatus having logic, modules, or circuitry to perform one or more elements of the method 200 or 600. In the context of method 200, this apparatus may be, for example, an apparatus of a UE (such as a wireless device 1102 that is a UE, as described herein). In the context of method 600, this apparatus may be, for example, an apparatus of a network device (such as a network device 1120, as described herein).

Embodiments contemplated herein include an apparatus having one or more processors and one or more computer-readable media, using or storing instructions that, when executed by the one or more processors, cause the one or more processors to perform one or more elements of the method 200 or 600. In the context of method 200, this apparatus may be, for example, an apparatus of a UE (such as a wireless device 1102 that is a UE, as described herein). In the context of the method 600, this apparatus may be, for example, an apparatus of a network device (such as a network device 1120, as described herein).

Embodiments contemplated herein include a signal as described in or related to one or more elements of the method 200 or 600.

Embodiments contemplated herein include a computer program or computer program product having instructions, wherein execution of the program by a processor causes the processor to carry out one or more elements of the method 200 or 600. In the context of method 200, the processor may be a processor of a UE (such as a processor(s) 1104 of a wireless device 1102 that is a UE, as described herein), and the instructions may be, for example, located in the processor and/or on a memory of the UE (such as a memory 1106 of a wireless device 1102 that is a UE, as described herein). In the context of method 600, the processor may be a processor of a network device (such as a processor(s) 1122 of a network device 1120, as described herein), and the instructions may be, for example, located in the processor and/or on a memory of the network device (such as a memory 1124 of a network device 1120, as described herein).

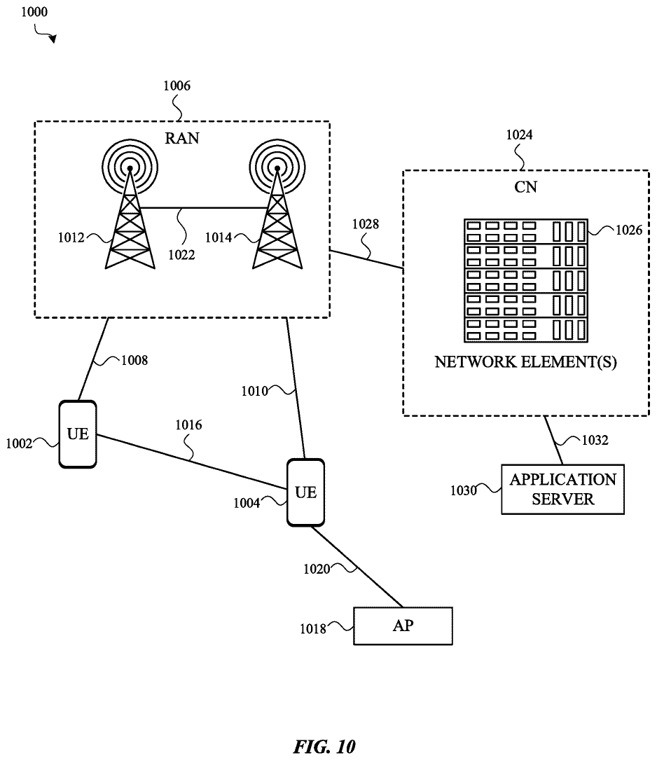

FIG. 10 illustrates an example architecture of a wireless communication system, according to embodiments described herein. The following description is provided for an example wireless communication system 1000 that operates in conjunction with the LTE system standards or specifications and/or 5G or NR system standards or specifications, as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more network devices, such as base station 1012 and base station 1014, that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more network devices of a RAN (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more network devices of a RAN (e.g., two or more gNBs and the like) that connect to the 5GC, between a base station 1012 (e.g., a gNB) connecting to the 5GC and an eNB, and/or between two eNBs connecting to the 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

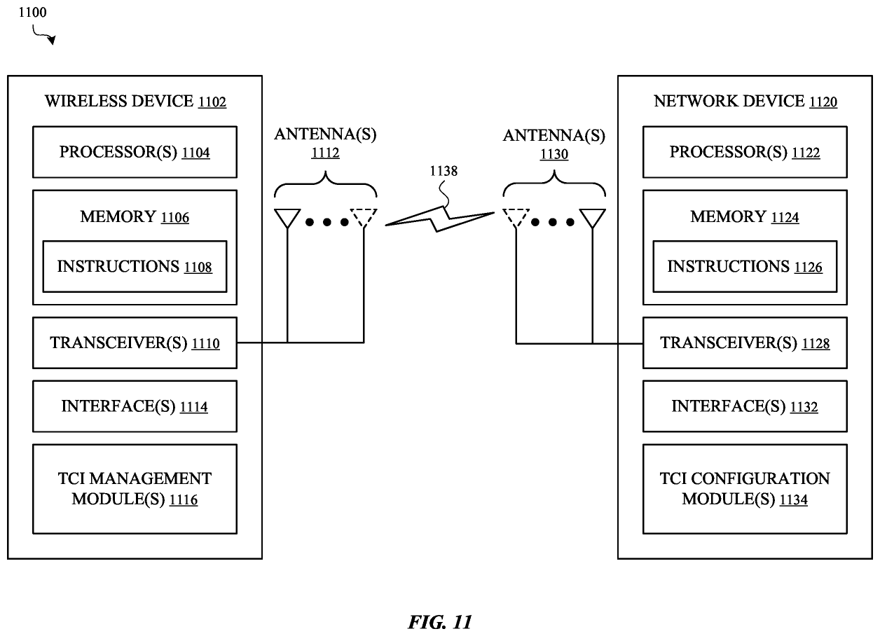

FIG. 11 illustrates an example system 1100 for performing signaling 1138 between a wireless device 1102 and a network device 1120, according to embodiments described herein. The system 1100 may be a portion of a wireless communication system as herein described. The wireless device 1102 may be, for example, a UE of a wireless communication system. The network device 1120 may be, for example, a base station (e.g., an eNB or a gNB) or a radio head of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 (also collectively referred to as a transceiver 1110) that may include radio frequency (RF) transmitter and/or receiver circuitry that use the antenna(s) 1112 of the wireless device 1102 to facilitate signaling (e.g., the signaling 1138) to and/or from the wireless device 1102 with other devices (e.g., the network device 1120) according to corresponding RATs.

The wireless device 1102 may include one or more antenna(s) 1112 (e.g., one, two, four, eight, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include TCI management module(s) 1116. The TCI management module(s) 1116 may be implemented via hardware, software, or combinations thereof. For example, the TCI management module(s) 1116 may be implemented as a processor, circuit, and/or instructions 1108 stored in the memory 1106 and executed by the processor(s) 1104. In some examples, the TCI management module(s) 1116 may be integrated within the processor(s) 1104 and/or the transceiver(s) 1110. For example, the TCI management module(s) 1116 may be implemented by a combination of software components (e.g., executed by a DSP or a general processor) and hardware components (e.g., logic gates and circuitry) within the processor(s) 1104 or the transceiver(s) 1110.

The TCI management module(s) 1116 may be used for various aspects of the present disclosure, for example, aspects of FIGS. 1-9, from a wireless device or UE perspective. The TCI management module(s) 1116 may be configured to, for example, parse and apply an active DL TCI state list update or an active UL TCI state list update that is received for the wireless device 1102 from the network device 1120.

The network device 1120 may include one or more processor(s) 1122. The processor(s) 1122 may execute instructions such that various operations of the network device 1120 are performed, as described herein. The processor(s) 1122 may include one or more baseband processors implemented using, for example, a CPU, a DSP, an ASIC, a controller, an FPGA device, another hardware device, a firmware device, or any combination thereof configured to perform the operations described herein.

The network device 1120 may include a memory 1124. The memory 1124 may be a non-transitory computer-readable storage medium that stores instructions 1126 (which may include, for example, the instructions being executed by the processor(s) 1122). The instructions 1126 may also be referred to as program code or a computer program. The memory 1124 may also store data used by, and results computed by, the processor(s) 1122.

The network device 1120 may include one or more transceiver(s) 1128 (also collectively referred to as a transceiver 1128) that may include RF transmitter and/or receiver circuitry that use the antenna(s) 1130 of the network device 1120 to facilitate signaling (e.g., the signaling 1138) to and/or from the network device 1120 with other devices (e.g., the wireless device 1102) according to corresponding RATs.

The network device 1120 may include one or more antenna(s) 1130 (e.g., one, two, four, or more). In embodiments having multiple antenna(s) 1130, the network device 1120 may perform MIMO, digital beamforming, analog beamforming, beam steering, etc., as has been described.

The network device 1120 may include one or more interface(s) 1132. The interface(s) 1132 may be used to provide input to or output from the network device 1120. For example, a network device 1120 of a RAN (e.g., a base station, a radio head, etc.) may include interface(s) 1132 made up of transmitters, receivers, and other circuitry (e.g., other than the transceiver(s) 1128/antenna(s) 1130 already described) that enables the network device 1120 to communicate with other equipment in a network, and/or that enables the network device 1120 to communicate with external networks, computers, databases, and the like for purposes of operations, administration, and maintenance of the network device 1120 or other equipment operably connected thereto.

The network device 1120 may include one or more TCI configuration module(s) 1134. The TCI configuration module(s) 1134 may be implemented via hardware, software, or combinations thereof. For example, the TCI configuration module(s) 1134 may be implemented as a processor, circuit, and/or instructions 1126 stored in the memory 1124 and executed by the processor(s) 1122. In some examples, the TCI configuration module(s) 1134 may be integrated within the processor(s) 1122 and/or the transceiver(s) 1128. For example, the TCI configuration module(s) 1134 may be implemented by a combination of software components (e.g., executed by a DSP or a general processor) and hardware components (e.g., logic gates and circuitry) within the processor(s) 1122 or the transceiver(s) 1128.

The TCI configuration module(s) 1134 may be used for various aspects of the present disclosure, for example, aspects of FIGS. 1-9, from a network device perspective. The TCI configuration module(s) 1134 may be configured to, for example, configure an active DL TCI state list update or an active UL TCI state list update for the wireless device 1102.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
receive, from a network, a medium access control (MAC) control element (CE) (MAC CE) carrying an active downlink transmission configuration indicator (TCI) state list update, the active downlink TCI state list update including a set of two or more new target TCI states associated with a set of two or more cells having different physical cell IDs (PCIs);
measure a set of two or more synchronization signal blocks (SSBs) associated with the set of two or more cells having different PCIs, the set of two or more SSBs associated with a set of two or more periodicities; and
receive a physical downlink control channel (PDCCH) or a physical downlink shared channel (PDSCH) in accord with at least one new target TCI state in the active downlink TCI state list update, the PDCCH or the PDSCH received after a delay, the delay including an SSB measurement delay related to measurement of the set of two or more SSBs, the SSB measurement delay dependent on,
a frequency range in which the set of two or more SSBs is measured; and
an overlap condition for the set of two or more periodicities, the overlap condition selected from a set of two or more overlap conditions.

2. The apparatus of claim 1, wherein:
the frequency range is a frequency range in which the processor simultaneously or contemporaneously measures SSBs of the set of two or more SSBs;
the overlap condition is a partial overlap condition, in which each cell of the two or more cells having different PCIs has a different time to first SSB following receipt of the MAC CE; and
the SSB measurement delay is based on a maximum time to first SSB, selected from the different times to first SSB following receipt of the MAC CE.

3. The apparatus of claim 1, wherein:
the frequency range is a frequency range in which the processor measures SSBs of the set of two or more SSBs using a set of two or more beams formed at two or more different times;
the overlap condition is a partial overlap condition, in which each cell of the two or more cells having different PCIs has a different time to first SSB following receipt of the MAC CE; and
the SSB measurement delay is based on a maximum time to first SSB, selected from the different times to first SSB following receipt of the MAC CE.

4. The apparatus of claim 1, wherein:
the frequency range is a frequency range in which the processor simultaneously or contemporaneously measures SSBs of the set of two or more SSBs;
the overlap condition is a partial overlap condition, in which each cell of the two or more cells having different PCIs has a same time to first SSB following receipt of the MAC CE; and
the SSB measurement delay is based on the same time to first SSB.

5. The apparatus of claim 1, wherein:
the frequency range is a frequency range in which the processor measures SSBs of the set of two or more SSBs using a set of two or more beams formed at two or more different times;
the overlap condition is a partial overlap condition, in which each cell of the two or more cells having different PCIs has a same time to first SSB following receipt of the MAC CE; and
the SSB measurement delay is based on the same time to first SSB plus a shortest period of the set of two or more periodicities.

6. The apparatus of claim 1, wherein:
the frequency range is a frequency range in which the processor simultaneously or contemporaneously measures SSBs of the set of two or more SSBs;
the overlap condition is a non-overlap condition, in which each cell of the two or more cells having different PCIs has a different time to first SSB following receipt of the MAC CE; and
the SSB measurement delay is based on a maximum time to first SSB, selected from the different times to first SSB following receipt of the MAC CE.

7. The apparatus of claim 1, wherein:
the frequency range is a frequency range in which the processor measures SSBs of the set of two or more SSBs using a set of two or more beams formed at two or more different times;
the overlap condition is a non-overlap condition, in which each cell of the two or more cells having different PCIs has a different time to first SSB following receipt of the MAC CE; and
the SSB measurement delay is based on a maximum time to first SSB, selected from the different times to first SSB following receipt of the MAC CE.

8. The apparatus of claim 1, wherein the set of two or more SSBs associated with the set of two or more cells having different PCIs includes:
a serving cell of a UE including the apparatus; and
a cell having a PCI that differs from a PCI of the serving cell.

9. The apparatus of claim 1, wherein the delay includes a sum of at least:
the SSB measurement delay;
a hybrid automatic repeat request (HARQ) reporting delay; and
a slot-dependent delay.

10. An apparatus comprising memory coupled to a processor, the processor configured to,
receive, from a network, a medium access control (MAC) control element (CE) (MAC CE) carrying an active uplink transmission configuration indicator (TCI) state list update, the active uplink TCI state list update including a set of two or more new target TCI states associated with a set of two or more cells having different physical cell IDs (PCIs);
measure a set of two or more pathloss reference signals (PL-RSs) associated with the set of two or more cells having different PCIs, the set of two or more PL-RSs associated with a set of two or more periodicities;
generate, for transmission, a physical uplink control channel (PUCCH) or a physical uplink shared channel (PUSCH) in accord with at least one new target TCI state in the active uplink TCI state list update, the PUCCH or the PUSCH transmitted after a delay, the delay including a PL-RS measurement delay related to measurement of the set of two or more PL-RSs, the PL-RS measurement delay dependent on,
a frequency range in which the set of two or more PL-RSs is measured; and
an overlap condition for the set of two or more periodicities, the overlap condition selected from a set of two or more overlap conditions.

11. The apparatus of claim 10, wherein:
the frequency range is a frequency range in which the processor simultaneously or contemporaneously measures PL-RSs of the set of two or more PL-RSs;
the overlap condition is a partial overlap condition, in which each cell of the two or more cells having different PCIs has a different time to first PL-RS following receipt of the MAC CE; and
the PL-RS measurement delay is based on,
a maximum time to first PL-RS, selected from the different times to first PL-RS following receipt of the MAC CE; and
a greatest period of the set of two or more periodicities.

12. The apparatus of claim 10, wherein:
the frequency range is a frequency range in which the processor measures PL-RSs of the set of two or more PL-RSs using a set of two or more beams formed at two or more different times;
the overlap condition is a partial overlap condition, in which each cell of the two or more cells having different PCIs has a different time to first PL-RS following receipt of the MAC CE; and
the PL-RS measurement delay is based on,
a maximum time to first PL-RS, selected from the different times to first PL-RS following receipt of the MAC CE; and
a greatest period of the set of two or more periodicities.

13. The apparatus of claim 10, wherein:
the frequency range is a frequency range in which the processor simultaneously or contemporaneously measures PL-RSs of the set of two or more PL-RSs;
the overlap condition is a partial overlap condition, in which each cell of the two or more cells having different PCIs has a same time to first PL-RS following receipt of the MAC CE; and
the PL-RS measurement delay is based on,
the same time to first PL-RS; and
a greatest period of the set of two or more periodicities.

14. The apparatus of claim 10, wherein:
the frequency range is a frequency range in which the processor measures PL-RSs of the set of two or more PL-RSs using a set of two or more beams formed at two or more different times;
the overlap condition is a partial overlap condition, in which each cell of the two or more cells having different PCIs has a same time to first PL-RS following receipt of the MAC CE; and
the PL-RS measurement delay is based on,
the same time to first PL-RS plus a shortest period of the set of two or more periodicities; and
a greatest period of the set of two or more periodicities.

15. The apparatus of claim 10, wherein:
the frequency range is a frequency range in which the processor simultaneously or contemporaneously measures PL-RSs of the set of two or more PL-RSs;
the overlap condition is a non-overlap condition, in which each cell of the two or more cells having different PCIs has a different time to first PL-RS following receipt of the MAC CE; and
the PL-RS measurement delay is based on,
a maximum time to first PL-RS, selected from the different times to first PL-RS following receipt of the MAC CE; and
a greatest period of the set of two or more periodicities.

16. The apparatus of claim 10, wherein:
the frequency range is a frequency range in which the processor measures PL-RSs of the set of two or more PL-RSs using a set of two or more beams formed at two or more different times;
the overlap condition is a non-overlap condition, in which each cell of the two or more cells having different PCIs has a different time to first PL-RS following receipt of the MAC CE; and
the PL-RS measurement delay is based on,
a maximum time to first PL-RS, selected from the different times to first PL-RS following receipt of the MAC CE; and
a greatest period of the set of two or more periodicities.

17. The apparatus of claim 10, wherein the set of two or more PL-RSs associated with the set of two or more cells having different PCIs includes:
a serving cell of a UE including the apparatus; and
a cell having a PCI that differs from a PCI of the serving cell.

18. The apparatus of claim 10, wherein the delay includes a sum of at least:
the PL-RS measurement delay;
a hybrid automatic repeat request (HARQ) reporting delay; and
a slot-dependent delay.

19. The apparatus of claim 10, wherein:
the processor is configured to,
determine that a target PL-RS required by the active uplink TCI state list update is not maintained; and
measure the set of two or more PL-RSs at least partly in response to the determination that the target PL-RS required by the active uplink TCI state list update is not maintained; wherein,
the target PL-RS required by the active uplink TCI state list update is determined to be not maintained when,
the target PL-RS is not in an active UL TCI state list; or
a number of PL-RSs in the active UL TCI state list exceeds four.

20. A method of wireless communication by a user equipment (UE), comprising:
receiving, from a network, a medium access control (MAC) control element (CE) (MAC CE) carrying an active downlink transmission configuration indicator (TCI) state list update, the active downlink TCI state list update including a set of two or more new target TCI states associated with a set of two or more cells having different physical cell IDs (PCIs);
measuring a set of two or more synchronization signal blocks (SSBs) associated with the set of two or more cells having different PCIs, the set of two or more SSBs associated with a set of two or more periodicities; and
receiving a physical downlink control channel (PDCCH) or a physical downlink shared channel (PDSCH) in accord with at least one new target TCI state in the active downlink TCI state list update, the PDCCH or the PDSCH received after a delay, the delay including an SSB measurement delay related to measurement of the set of two or more SSBs, the SSB measurement delay dependent on,
a frequency range in which the set of two or more SSBs is measured; and
an overlap condition for the set of two or more periodicities, the overlap condition selected from a set of two or more overlap conditions.
